(19) United States
(12) Patent Application Publication
(10) Pub. No.: US 2013/0048932 A1
(43) Pub. Date: Feb. 28, 2013

(54) Multi-Directional Hydraulic Systems And Apparatus

(71) Applicant: Chun Ho Lu, Chiayi City (TW)

(72) Inventor: Chun Ho Lu, Chiayi City (TW)

(73) Assignee: SHINN FU CORPORATION, Taipei City (TW)

(21) Appl. No.: 13/218,158

(22) Filed: Aug. 25, 2011

(51) Int. Cl. B66F 3/24; F15D 1/00

(52) U.S. Cl. 254/93 R; 137/561 R; 137/544

(57) ABSTRACT

Multi-directional jacks and hydraulic systems are set forth. In one embodiment, a fluid collecting system in a hydraulic apparatus includes an elongate housing for holding fluid, a guide bar, a guide block, and a collection hose. The elongate housing has proximal and distal ends, and the guide bar extends between the proximal and distal ends. The guide block is coupled to the guide bar for sliding movement along the guide bar toward the proximal and distal ends; the sliding movement of the guide block is caused by orientation of the elongate housing and gravity. The collection hose extends inside the housing and is coupled to the guide block such that an open end of the collection hose is adjacent the housing distal end when the guide block is at a maximum amount of travel toward the distal end.

### BACKGROUND

The disclosed subject matter is directed to hydraulic systems and apparatus (e.g., jacks).

Various hydraulic systems for operating lifting apparatus exist in the prior art. Most typically, prior art hydraulic systems include a fluid reservoir, a piston housing, a piston that extends from—and retracts into—the piston housing, and a pump. The pump moves fluid between the piston housing and the fluid reservoir to raise and lower the piston.

Prior art systems commonly experience failures when not properly oriented. More particularly, when improperly oriented, prior art systems typically cannot reliably deliver hydraulic fluid free of air. Instead, they experience interruptions in fluid flow that could diminish hydraulic properties in the systems. The diminished hydraulic properties can render the systems ineffective and even dangerous.

### SUMMARY

Multi-directional jacks and hydraulic systems are set forth herein. According to one embodiment, a fluid collecting system in a hydraulic apparatus includes an elongate housing for holding fluid, a guide bar, a guide block, and a collection hose. The elongate housing has proximal and distal ends, and the guide bar extends between the proximal and distal ends. The guide block is coupled to the guide bar for sliding movement along the guide bar toward the proximal and distal ends; the sliding movement of the guide block is caused by orientation of the elongate housing and gravity. The collection hose extends inside the housing and is coupled to the guide block such that an open end of the collection hose is adjacent the housing distal end when the guide block is at a maximum amount of travel toward the distal end.

According to another embodiment, a hydraulic jack includes a piston housing, a piston that extends from and retracts into the piston housing, an elongate housing for holding fluid, a guide bar, a guide block, a collection hose, and a pump. The elongate housing has proximal and distal ends, and the guide bar extends between the proximal and distal ends. The guide block is coupled to the guide bar for sliding movement along the guide bar toward the proximal and distal ends; sliding movement of the guide block is caused by orientation of the elongate housing and gravity. The collection hose extends inside the housing and is coupled to the guide block such that an open end of the collection hose is adjacent the housing distal end when the guide block is at a maximum amount of travel toward the distal end. The pump is configured to move fluid from the collection hose to the piston housing for extending the piston.

### BRIEF DESCRIPTION OF THE DRAWINGS

FIG. 1 is a side view of a portion of a hydraulic apparatus according to an embodiment, with the guide block at the proximal end of the elongate housing.

FIG. 2 is another side view of the portion of hydraulic apparatus of FIG. 1, with the guide block at the distal end of the elongate housing.

FIG. 3 is yet another side view of the portion of hydraulic system of FIG. 1, with the guide block at the distal end of the elongate housing and rotated about one hundred and eighty degrees about the guide bar.

FIG. 4 is a perspective view of the guide block of FIG. 1, according to an embodiment.

FIG. 5 is an end view of the guide block of FIG. 4.

FIG. 6 is a side view of a portion of a hydraulic apparatus according to another embodiment, with the guide block at the proximal end of the elongate housing.

FIG. 7 is another side view of the portion of hydraulic apparatus of FIG. 6, with the guide block at the distal end of the elongate housing.

### DETAILED DESCRIPTION

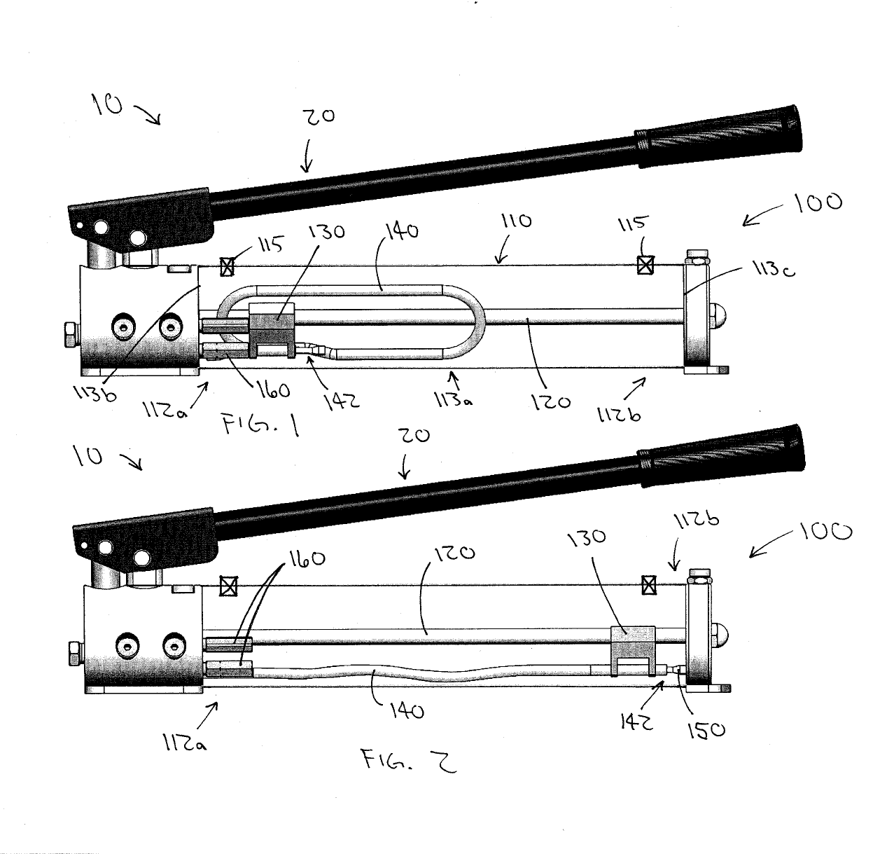

FIGS. 1 through 5 show a portion of a hydraulic apparatus 10 (e.g., a jack) according to one embodiment. The hydraulic apparatus 10 has a fluid collecting system 100, a piston housing (not shown), a piston (not shown) that extends from and retracts into the piston housing, and a pump 20.

The fluid collecting system 100 includes an elongate housing 110 for holding fluid (e.g., hydraulic fluid), a guide bar 120, a guide block 130, and a collection hose 140. As shown in FIGS. 1 through 3, the elongate housing 110 has proximal and distal ends 112a, 112b, and an air vent 115 may be located at each end 112a, 112b for releasing air from inside the elongate housing 110. Any appropriate material may be used to construct the elongate housing 110, such as metals and plastics. In the embodiment shown in the drawings, the elongate housing 110 includes a transparent central portion 113a between non-transparent end walls 113b, 113c, and the central portion 113a is generally cylindrical with a generally circular cross section. In other embodiments, the central portion 113a may be shaped differently and/or be non-transparent.

The guide bar 120 extends between the proximal and distal ends 112a, 112b of the elongate housing 110, as shown in FIGS. 1 through 3. In the embodiment shown in the drawings, the guide bar 120 extends entirely from one end wall 113b to the other 113c, is generally cylindrical with a generally circular cross section, and extends generally along an imaginary center axis of the elongate housing 110. In other embodiments, the guide bar 120 may extend only partially between the end walls 113b, 113c, may be shaped differently, and/or may be off-center. Any appropriate material may be used to construct the guide bar 120, and in some embodiments the guide bar 120 may be partially or fully hollow.

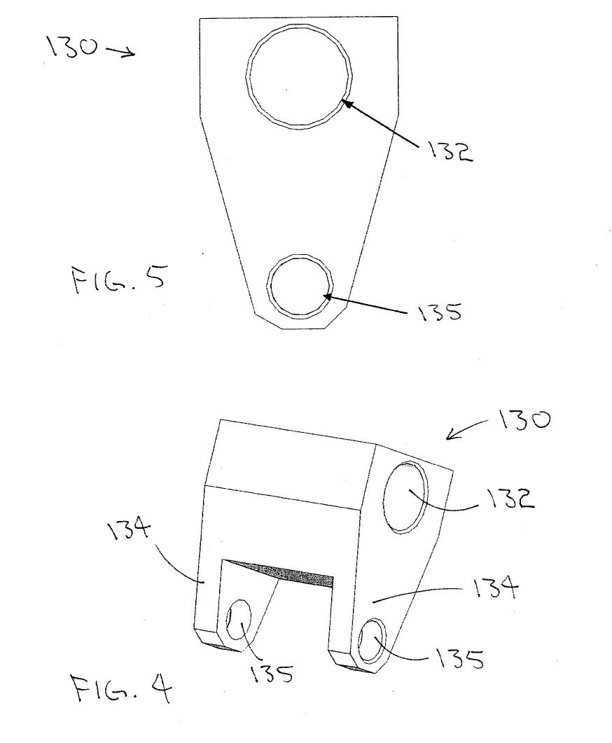

The guide block 130 (FIGS. 4 and 5) is coupled to the guide bar 120, as shown in FIGS. 1 through 3, for sliding movement along the guide bar 120 toward the proximal and distal ends 112a, 112b. For example, the guide block 130 may include a gliding hole 132 that is sized complementary to the guide bar 120, and the guide bar 120 may pass through the gliding hole 132. As such, the orientation of the elongate housing 110 and gravity may cause the guide block 130 to slide along the guide bar 120. Metals, plastics, and other appropriate materials may be used to construct the guide block 130, and properties such as mass may be selected based on the desired movement of the guide block 130 along the guide bar 120 and other considerations. In some embodiments, the guide block 130 may be rotatable about the guide bar 120; in other embodiments, the interaction between the guide block 130 and the guide bar 120 may prevent the guide block 130 from substantially rotating about the guide bar 120.

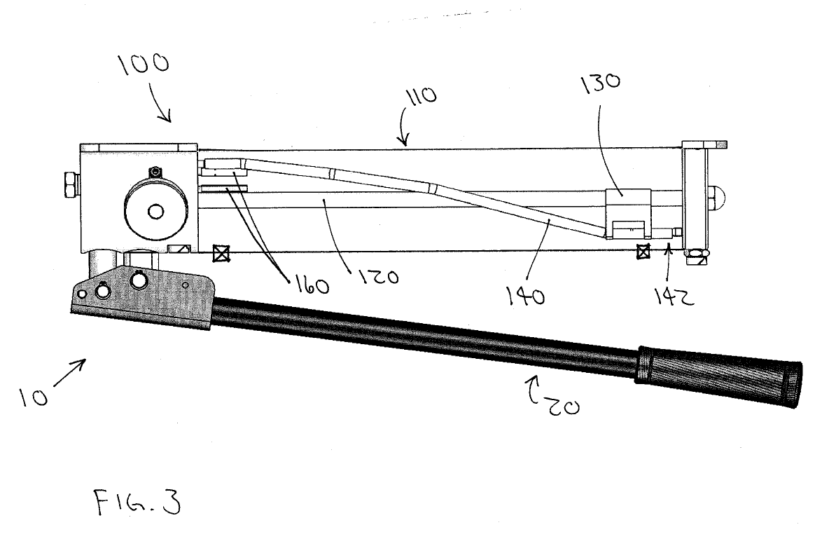

The collection hose 140 extends inside the elongate housing 110 and is coupled to the guide block 130 such that an open end 142 of the collection hose 140 is adjacent the housing distal end 112b when the guide block 130 is at a maximum amount of travel toward the distal end 112b (FIG. 2). As shown in FIG. 4, the guide block 130 may include at least one attachment arm 134 with a port 135 through which the collection hose 140 may pass. It may be desirable to utilize multiple arms 134 (FIG. 4) or a single arm 134 of sufficient length for the collection hose 140 to be maintained generally parallel to the guide bar 120 at the guide block 130. The collection hose 140 may be joined to the ports 135 in an interference fit, or adhesive or mechanical fasteners may restrict the collection hose 140 from separating from the arms 134. While it may be particularly desirable (as shown in FIGS. 1 through 3) for the collection hose 140 to be tubing that is bendable and resilient (constructed, for example, of silicone, plastic, or rubber) and that has generally constant diameter, it may also be acceptable for the collection hose 140 to be accordion tubing capable of expanding and contracting to provide various lengths.

100181 Particularly if the guide block 130 and the guide bar 120 are collectively configured to allow the guide block 130 to rotate about the guide bar 120, the center of gravity of the guide block 130 may be offset so that the arms 134 are biased to rotate lower than the gliding hole 132 when the guide bar 120 is generally horizontal. To provide sufficient access to fluid at the housing distal end 112b and also prevent the collection hose 140 from tangling inside the housing 110, the collection hose may have a length that is greater than a distance between the proximal and distal ends 112a, 112b of the housing 110, but that is sufficiently short to limit the guide block to rotating a predetermined amount (e.g., three hundred and sixty degrees) about the guide bar 120.

A filter 150 may be coupled to the collection hose 140 adjacent the open end 142 so that debris and unwanted substances are not passed through the collection hose 140. In some embodiments, the filter 150 may be inserted into the collection hose 140, causing or enhancing the interference fit between the collection hose 140 and the ports 135.

As shown in FIG. 1, at least one spacer 160 may be located in the elongate housing 110 at the proximal end 112a to prevent the guide block 130 from reaching the housing proximal end 112a—and particularly to prevent the collection hose 140 from crushing or bending, which could restrict the fluid from moving in and out of the elongate housing 110.

Turning now to the pump 20, the pump 20 is configured to move fluid from the collection hose 140 to the piston housing for extending the piston. The pump 20 may be a manual pump (as shown in FIGS. 1 through 3), or may be an automated (e.g., electric powered) pump. Like pistons and piston housings, pumps are well known in the art and need no further discussion.

To operate the jack 10, the pump 20 moves fluid from the collection hose 140 to the piston housing, and the fluid forces the piston to extend from the piston housing. To return the piston into the piston housing, the fluid is released from the piston housing and deposited back in the elongate housing 110. While various fluids may be employed, it may be desirable for the fluid to be a hydraulic fluid that functions at least when at −30° F. and above.

To allow the jack 10 to operate in various orientations, the fluid collecting system 100 ensures that fluid is available to the collection hose 140 for supplying to the piston housing. When the housing distal end 112b is oriented below the housing proximal end 112a, the guide block 130 travels along the guide bar 120 toward the distal end 112b due to gravity (FIG. 2). This places the hose end 142 adjacent the housing distal end 112b, where the fluid collects due to gravity. If the elongate housing 110 is rotated, the guide block 130 may rotate about the guide bar 120 as discussed above so that the hose end 142 remains at the lowermost point of the housing distal end 112b. Accordingly, it may be acceptable for less fluid to be held in the elongate housing 110 in embodiments allowing the guide block 130 to rotate about the guide bar 120 than in embodiments that do not allow such rotation, and embodiments allowing rotation may be used in more orientations than embodiments that do not allow such rotation.

When the housing proximal end 112a is oriented below the housing distal end 112b, the guide block 130 travels along the guide bar 120 toward the proximal end 112a due to gravity (FIG. 1). This places the hose end 142 adjacent the housing proximal end 112a, where the fluid collects due to gravity. The spacers 160 may provide a sufficient amount of space under the guide block 130 to prevent the collection hose 140 from being crushed or kinked. As discussed above, if the elongate housing 110 is rotated, the guide block 130 may rotate about the guide bar 120.

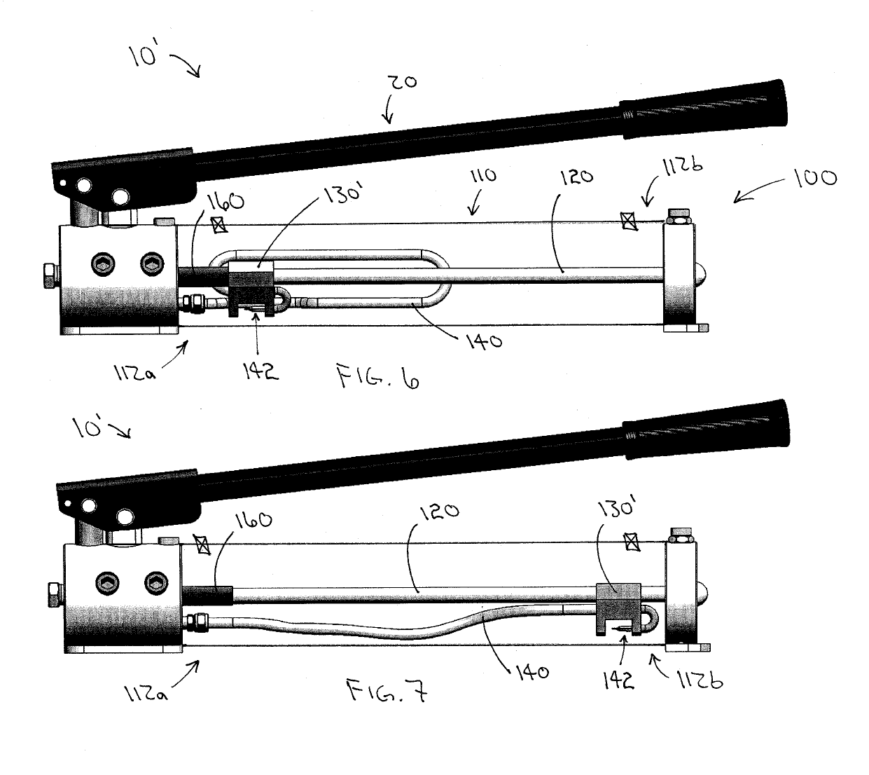

FIGS. 6 and 7 show a portion of a hydraulic apparatus 10′ (e.g., a jack) according to another embodiment. The hydraulic apparatus 10′ is substantially similar to the hydraulic apparatus 10, except as specifically noted and/or shown, or as would be inherent. Further, those skilled in the art will appreciate that the apparatus 10 (and thus the apparatus 10′) may be modified in various ways, such as through incorporating all or part of any of the various described embodiments, for example. For uniformity and brevity, corresponding reference numbers may be used to indicate corresponding parts, though with any noted deviations.

The primary difference between apparatus 10′ and apparatus 10 is that the apparatus 10′ replaces the guide block 130 with an alternative guide block 130′. Compared to the guide block 130, the guide block 130′ includes an additional passage, allowing the collection hose 140 to pass through the guide block 130′ and then curve back toward the housing proximal end 112a as shown. As those skilled in the art will appreciate, the collection hose 140 may be a unitary hose, or may be constructed of multiple hoses; and the guide block 130′ may even form a portion of the collection hose 140. By using the guide block 130′, the open end 142 of the collection hose 140 may be protected between the arms 134. FIG. 6 shows the guide block 130′ and the hose end 142 adjacent the proximal end 112a of the elongate housing 110, and FIG. 7 shows the guide block 130′ and the hose end 142 adjacent the distal end 112b of the elongate housing 110.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. Further, it will be understood that certain features and subcombinations are of utility and may be employed without reference to other features and subcombinations and are contemplated within the scope of the claims. Moreover, various steps set forth herein may be carried out in orders that differ from those set forth herein without departing from the scope of the present methods. The description should not be restricted to the above embodiments, but should be measured by the following claims.

What is claimed is:

1. A fluid collecting system in a hydraulic apparatus, comprising:
an elongate housing for holding fluid, the elongate housing having proximal and distal ends;
a guide bar extending between the proximal and distal ends;
a guide block coupled to the guide bar for sliding movement along the guide bar toward the proximal and distal ends, sliding movement of the guide block being caused by orientation of the elongate housing and gravity;
a collection hose extending inside the housing, the collection hose being coupled to the guide block such that an open end of the collection hose is adjacent the housing distal end when the guide block is at a maximum amount of travel toward the distal end.

2. The system of claim 1, further comprising a spacer in the housing at the housing proximal end to prevent the guide block from reaching the housing proximal end.

3. The system of claim 1, further comprising a filter coupled to the collection hose adjacent the collection hose open end.

4. The system of claim 1, wherein the guide block is rotatable about the guide bar.

5. The system of claim 4, wherein the collection hose has a length that is greater than a distance between the proximal and distal ends of the housing.

6. The system of claim 5, where in the collection hose length is sufficiently short to limit the guide block to rotating about three hundred and sixty degrees about the guide bar.

7. The system of claim 6, further comprising:
a spacer in the housing at the housing proximal end to prevent the guide block from reaching the housing proximal end;
a filter coupled to the collection hose adjacent the collection hose open end; and
a first air vent at the housing proximal end and a second air vent at the housing distal end for releasing air from inside the housing.

8. The system of claim 1, wherein the guide bar and the guide block are configured such that the guide block does not substantially rotate about the guide bar.

9. The system of claim 1, further comprising a first air vent at the housing proximal end and a second air vent at the housing distal end for releasing air from inside the housing.

10. A hydraulic jack, comprising:
a piston housing;
a piston that extends from and retracts into the piston housing;
an elongate housing for holding fluid, the elongate housing having proximal and distal ends;
a guide bar extending between the proximal and distal ends;
a guide block coupled to the guide bar for sliding movement along the guide bar toward the proximal and distal ends, sliding movement of the guide block being caused by orientation of the elongate housing and gravity;
a collection hose extending inside the housing, the collection hose being coupled to the guide block such that an open end of the collection hose is adjacent the housing distal end when the guide block is at a maximum amount of travel toward the distal end; and
a pump configured to move fluid from the collection hose to the piston housing for extending the piston.
